(19) United States
(12) Patent Application Publication
(10) Pub. No.: US 2017/0280837 A1
(43) Pub. Date: Oct. 5, 2017

(54) SELF-DEFENSE TIGER CLAW RING

(71) Applicant: Samuel Simkin-Brocato, Hanover, MD (US)

(72) Inventor: Samuel Simkin-Brocato, Hanover, MD (US)

(21) Appl. No.: 15/402,101

(22) Filed: Jan. 9, 2017

Related U.S. Application Data
(60) Provisional application No. 62/276,006, filed on Jan. 7, 2016.
(60) Provisional application No. 62/277,017, filed on Jan. 11, 2016.

(51) Int. Cl. A44C 9/00; F41B 13/00; F41B 15/08; B26B 27/00

(52) U.S. Cl. CPC A44C 9/0053; B26B 27/007; F41B 13/00; F41B 15/08

(57) ABSTRACT

A self-defense ring having a single protrusion in the shape of a talon or claw to increase gripping strength and/or to increase open hand strike capability in case of attack by an assailant. The ring may be also worn during daily routines without causing injury to the user or to others.

### BACKGROUND OF THE INVENTION

### Field of the Invention

The invention relates to hand-held and/or hand-mounted self-defense devices.

### Description of the Background

For millennia men and women have had to defend themselves against assailants, and humankind has developed an infinite variety of tools and weapons, both lethal and non-lethal, for self-defense. Many of them require rudimentary to advanced martial arts or hand to hand training to use effectively.

There is a famous line in the Bubishi, the ancient Chinese text that shaped the way karate developed on the island of Okinawa, relating to the generation of power through the use of weight. It remarks that the tiger does not bring down its prey with its claws, they are just the instrument through which it applies its weight.

In terms of combat, the meaning is simple: don't punch with just the arm and shoulder; instead, use all of the body's weight when striking. But watching the big cats hunt, pouncing onto fleeing prey, latching on with their claws, and using its weight to drag the prey to the ground, one can find inspiration for the grappling game as well. A lion or tiger will swat at rivals or its cubs with its paws, but their greatest weapon is their tremendous weight combined with their agility, leveraged into their claws.

One type of self-defense tool from ancient times is the Kakute death ring; see FIG. 1. Users wore these rings, one on the middle finger and a second on the thumb, with their spikes hidden in their palms. Serge Mol, author of Classical Fighting Arts of Japan, writes “The main purpose of the [Kakute] was to gain a firm hold on an opponent, with the teeth digging into pressure points to cause pain . . . The surprise effect of this weapon would cause an opponent to lose concentration, making follow-up techniques easier.”

All other self-defense rings (See, e.g., FIGS. 2 and 3) are designed to be used with a closed hand strike. They are either heavy in weight or designed with a protruding spike that is designed for closed handed punches. This makes them offensive weapons in the eyes of the law in most cases and could fall into the same category as brass knuckles (FIG. 4), and they are therefore illegal in many places.

The disadvantage of all of these devices is the strength and skill necessary to wield them properly, and, except in the case of the Kakute rings, the inability of the devices to assist the user in restraining an assailant. In the case of the Kakute rings, the straight and sharp spikes make them dangerous to all but the trained user, and they are not suitable for wearing during the performance of routine daily tasks.

### SUMMARY OF THE INVENTION

This invention is configured to be worn on the inside of the hand and is made to be more versatile, instinctive, comfortable to wear all day long without getting in the way or attracting unwanted attention or looking like a offensive weapon. The user can shake another person's hand while wearing it, and there will be no discomfort to the other person. It is adapted to become part of the user's hand and natural movements.

The unique way that it integrates into and becomes an extension of the hand of the user with almost zero sacrifice in dexterity is unmatched by any prior device. The rings of the invention curl with the hand and reinforce the grip, and provide non-lethal open palm striking surface. It is highly effective in close quarters combat and grappling.

Using the invention, the user has the choice to keep the aggressor at arms-length or to get very close with no sacrifice to the effectiveness of the self-defense tool.

The invention does not require any specialized martial arts training to utilize effectively—it simply becomes part of the users hand and a user cannot be forced to release it simply by having the hand forced open.

This invention was developed for the purpose of being a compliance device to assist in controlling aggressive or violent individuals while doing non-lethal damage by enhancing the grip strength of the wearer exponentially and giving the wearer the ability to control the assailant and gain advantages via pain deterrence.

The ring of the invention is preferably worn on the first finger of a user's hand and features a claw intended to be worn facing the palm of a user's hand. The shape resembles a canine tooth, but can be made to resemble any curved tooth, claw or talon, to prevent an assailant from pulling away from the hand grip of the person wearing the ring.

The tip of the claw may be roughened or even sharpened to facilitate the gathering of DNA from an assailant to assist in assailant identification. No other device magnifies the user's natural grip strength to this level or provides the inherent versatility of letting the wearer choose between open handed, close handed, or gripping\grappling techniques that may need to be used in a multitude of defensive scenarios.

The present invention mechanically leverages the user's natural grip strength and striking effectiveness, multiplying the natural grip strength by concentrating it into a small area by placing a claw not at the tips of the fingers, but at a location in the hand that maximizes the strength and leverage of the hand, instead of merely the ends of the fingers, thus maximizing the user's grip force and allowing the user to apply crushing force with minimal effort, without interfering with natural use of the hands in daily and even delicate activities, including reaching into one's pocket, eating, shaking hands with another person, or even changing a baby's diaper.

### BRIEF DESCRIPTION OF THE DRAWINGS

FIG. 1 shows a version of a prior art punching ring.

FIG. 2 shows another version of a prior art punching ring.

FIG. 3 shows several versions of prior art brass knuckles.

FIG. 4 shows prior art Kakute rings.

FIG. 5 shows a top/plan view of an embodiment of the invention.

FIG. 6 shows a perspective view of the embodiment of the invention shown in FIG. 5.

FIG. 7 shows a side view of the embodiment of the invention shown in FIG. 5.

FIG. 8 shows a front view of the embodiment of the invention shown in FIG. 5.

FIG. 9 shows a side view of another embodiment of the invention, for ring size 10.5, with dimensions.

FIG. 10 shows top and side views of yet another embodiment of the invention.

FIG. 11 shows a user wearing an embodiment of the invention.

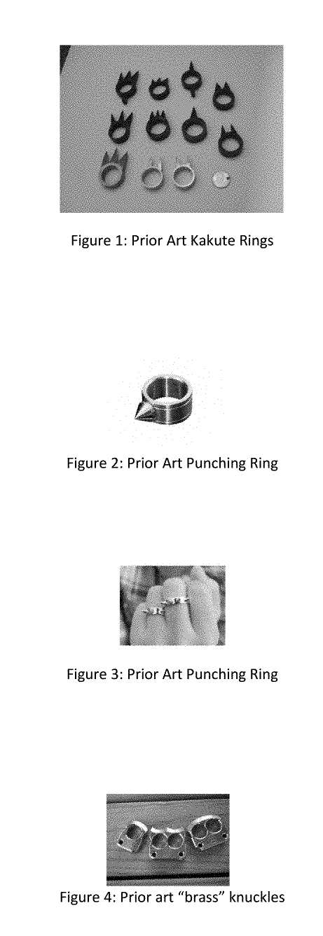

### DETAILED DESCRIPTION OF THE INVENTION

The invention summarized above may be better understood by referring to the following description, claims, and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form. Further, it should be understood that the figures are not drawn to scale and in some instances details that are not necessary for the understanding of the present invention are omitted such as common methods of manufacturing.

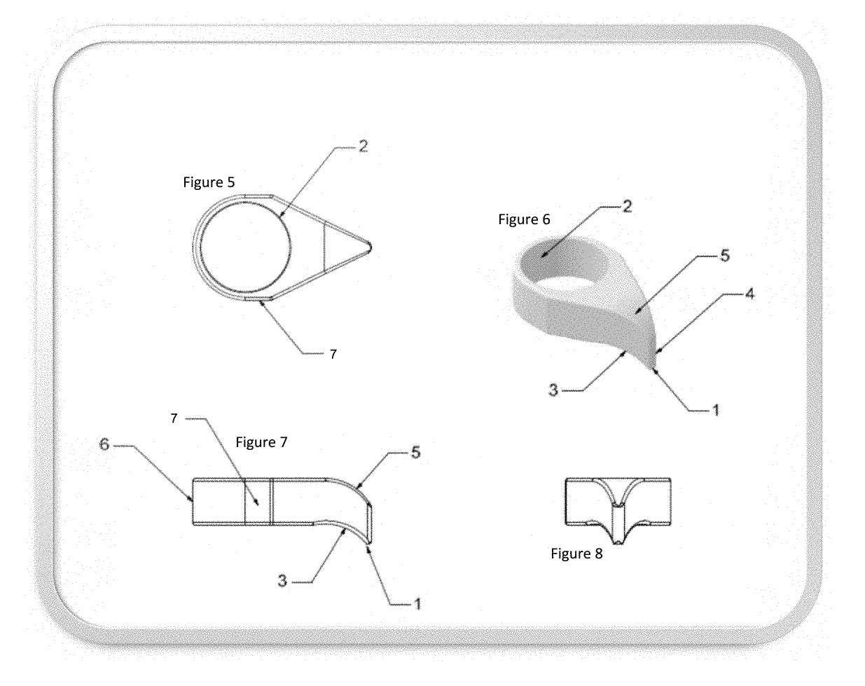

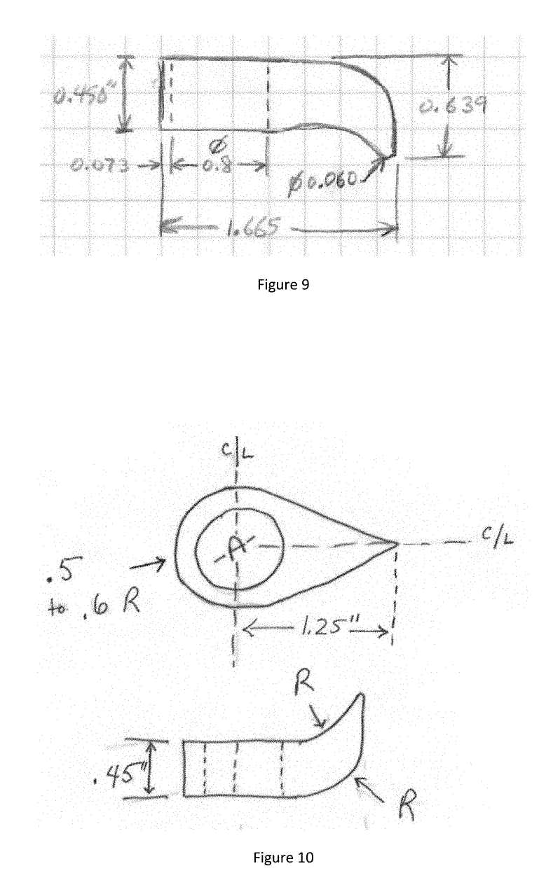

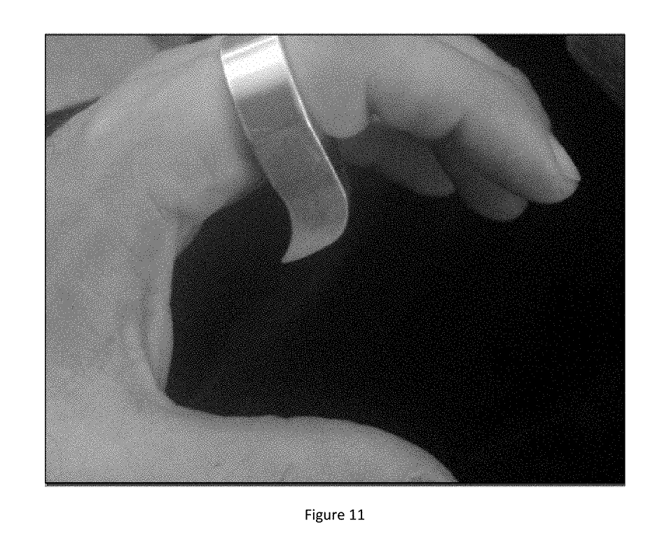

The invention is a ring with a single talon or claw shape extending away from the center of the ring in only a single direction, as shown in FIGS. 5-8, and is most advantageously used when worn at the base of the index finger of a user's dominant hand, as shown in FIG. 11.

Referring to FIGS. 5 through 8, a primary feature of the invention is the talon or claw, the tip of which is designated by reference numeral 1. This is the point at where all of a user's grip strength may be concentrated into a very small area, exponentially multiplying grip strength into an intimidating and possibly damaging force due to its location at the base of the finger. While the tip of the claw 1 is preferably not sharpened, so as to be suitable for use during routine daily activities, it preferably has a roughness or edge that if sufficient force is brought to bear on an assailants wrist, hand, or other body part during self-defense, it will collect and retain assailant DNA so as to assist law enforcement with finding the assailant. The size and curvature of the claw, together with its location at the base of a user's finger, further takes advantage of instinctive clawing defense tactics as would be intuitive to an untrained victim, including gripping and pulling away tactics, such as grabbing the hand or wrist of the assailant when they are holding onto the victim and pulling in the opposite direction of the body of the victim. In addition, the dimensions of the claw portion of the ring take into account the depths of the skeletal musculature structure of both the assailant and the victim, as well as the location of subcutaneous nerve endings, so as to cause non-lethal discomfort to the assailant without discomfort to the user; see FIGS. 6 and 7.

The inner diameter of the ring 2 is preferably sized to the user so that it can be worn comfortably during everyday activities, in which case, the claw may be tucked comfortably into the proximal palmar crease, hence increasing the versatility and enhancing the optional use state without injury to the wearer. According to a preferred embodiment, the ring may be sized one-half a size larger than the user's normal ring size to accommodate the width of the band as well as the natural taper of the finger. A larger width of the band gives stability and to prevent the creation of a dynamic fulcrum point on the user's finger.

Interior radius 3 of the claw or talon area preferably matches the proximal palmar crease of the palm to fold comfortably and naturally into the palm when not required.

Log-splitter or wedge on the front face of the claw 4 may be used for striking as well as spreading or wedging into vulnerable areas of an assailant, again without causing lethal damage.

Top surface of the claw 5 is preferably configured to fit smoothly against the palm side of the finger upon which the ring is worn when the user's hand is in a gripping configuration (half closed or nearly closed fist) in order to reinforce the user's grip on an assailant and add pressure as needed in its various functions of versatile defensive techniques. Top surface 5 is also a safe area that is utilized when not employing the clawed grip. No damage can occur to the person or object gripped when this area is used to lift or carry everyday objects, such as keys, grocery bags, boxes, or living things such as small children and pets. Indeed, when not in use as a self-defense device, the ring of the invention can be rotated slightly by a push of the thumb so that a side face of the claw rests comfortably against an adjacent finger, allowing activity such as a handshake to occur without injury or discomfort to either party. The invention is thus natural and non-inhibiting when doing natural actions such as reaching into a pocket to retrieve items. The lack of encumbrance is something no other self-defense ring offers.

The width of the ring band 6 is adapted for comfort and style.

Flattened areas 7 are likewise ornamental, but facilitate a firm grip on the ring when a user is executing an open hand strike with area 4 while using the open handed strike technique. Flattened area 7 also allows for the ring to mate with a matching surface on another ring according to the invention on an adjacent finger, should the user choose to wear more than one ring according to the invention. In this manner, two rings worn on adjacent fingers could work in conjunction with one-another for self-defense gripping and open-hand strikes.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A self-defense ring comprising:
a generally annular structure defining an inner surface, an outer surface, a top surface and a bottom surface, said inner surface adapted to receive a wearer's finger or thumb; said outer surface having a first side and a second side opposite said first side, said first side of said outer surface characterized by a semi-circular shape generally corresponding to a shape of a corresponding portion of said inner surface; said second side of said outer surface defining a single triangular protrusion integrally formed as an extension of an entire width of said outer surface, wherein top and bottom surfaces of said triangular protrusion curve downward with a corresponding radius of curvature; said outer surface defining a wedge shape at a distal vertex of said triangular protrusion, wherein said bottom surface of said triangular protrusion and a bottom edge of said wedge shape intersecting at a tip.

2. A self-defense ring according to claim 1, wherein said wedge shape terminates in a blunt edge.

3. A self-defense ring according to claim 1, wherein said tip is a blunt tip.

4. A self-defense ring according to claim 1, wherein said wedge shape terminates in a sharpened edge.

5. A self-defense ring according to claim 1, wherein said tip is a sharpened tip.
